(19) United States
(12) Patent Application Publication
(10) Pub. No.: US 2025/0039355 A1
(43) Pub. Date: Jan. 30, 2025

(54) IMAGE PROCESSING APPARATUS, IMAGE PICKUP APPARATUS, IMAGE PROCESSING METHOD, AND STORAGE MEDIUM

(71) Applicant: CANON KABUSHIKI KAISHA, Tokyo (JP)

(72) Inventor: ATSUTO NODA, Tokyo (JP)

(21) Appl. No.: 18/753,056

(22) Filed: Jun. 25, 2024

(30) Foreign Application Priority Data
Jul. 28, 2023 (JP) 2023-123529

(51) Int. Cl. H04N 13/398; G06T 3/60; H04N 13/344

(52) U.S. Cl. CPC H04N 13/398; G06T 3/60; H04N 13/344

(57) ABSTRACT

An image processing apparatus includes a memory storing instructions, and a processor configured to execute the instruction to acquire a first image and a second image with parallax, or one image including the first image and the second image, output one stereoscopic viewable image by setting the first image as a right-eye image and the second image as a left-eye image in a first mode, and output one stereoscopic viewable image by setting the first image as the left-eye image and the second image as the right-eye image, and by rotating the first image and the second image around an optical axis in a second mode.

### BACKGROUND

### Technical Field

One of the aspects of the embodiments relates to an image processing apparatus, an image pickup apparatus, an image processing method, and a storage medium.

### Description of Related Art

Japanese Patent No. 5166650 discloses an image pickup apparatus that can capture images at once from two optical systems in order to capture two images with parallax using the two optical systems, and to allow these images to be stereoscopically viewed with a Virtual Reality (VR) device. In viewing with VR goggles, in order to provide not only a three-dimensional sense but also immersion, a captured moving or still image may have an angle of view of 180 degrees or more. In order to provide an image with an angle of view of at least 180 degrees under manufacturing errors, an imaging lens may be a lens configured to capture an image at an angle of view exceeding 180 degrees. The form of an image input to a VR viewing device, such as VR goggles, is one widely expressed in an equidistant cylindrical projection method. As mentioned above, a fisheye lens is used to express an image with an angle of view of about 180°. Properly correcting a distorted image captured with the fisheye lens using an equidistant cylindrical projection method can display an image that is close to what the human eye sees on a display unit that corresponds to each of the left and right eyes.

Japanese Patent Laid-Open No. 2021-129169 discloses an image processing unit configured to detect a rotational position shift of a captured image and to correct the captured image so as to horizontalize a tilted captured image. The rotational shift amount may be detected using an acceleration sensor in the camera, and the rotational shift of the captured image may be corrected according to the rotational shift amount.

The image pickup apparatus disclosed in Japanese Patent No. 5166650 can output a stereoscopic image that is a set of left and right images formed by left and right lenses on an image sensor. Assume that a lateral direction of a twin-lens camera including two optical systems is an x-axis, a vertical direction is a y-axis, and a depth direction is a z-axis. In this case, for example, in a case where an image is captured with a rotational shift around the z-axis and viewed on a head mount display (HMID) as a VR viewing device, the HMID displays a horizontal line tilted by the rotational shift. Thus, due to a shift between the VR-displayed image and the sense in the gravity direction, VR sickness may occur.

In VR imaging, basically, the user may horizontally fix the twin-lens camera, but an image may be captured at a slight tilt. Accordingly, the attitude (or orientation) of the camera is detected from information such as an acceleration sensor in the camera, a rotational shift amount is recorded as a rotational shift correction parameter linked to the captured image, and the rotational shift of the captured image is corrected. Thereby, a VR image can be created in a highly accurate horizontal state. As the rotational shift amount increases, not only the horizontal parallax (parallax between the left and right) between the two optical systems but also the vertical parallax (parallax between the up and down) between them increases. Even if the rotational shift correction is performed for a captured image with a large rotational shift amount, the vertical parallax cannot be removed, so the vertical parallax also affects VR viewing. For example, in an image captured with a twin-lens camera rotated by 90 degrees, that is, with the camera in the vertical state, the horizontal parallax becomes zero, and only the vertical parallax remains. Thus, a VR image in which a rotational shift of 90 degrees has been corrected cannot provide accurate stereoscopic viewing.

An image captured with the twin-lens camera rotated by 180 degrees, that is, with the camera upside down, has a horizontal parallax and no vertical parallax, but the VR image in which a rotational shift of 180 degrees has been corrected cannot be stereoscopically viewed. This is because, in a state rotated by 180 degrees, the left lens of the twin-lens camera corresponds to the human right eye, and the right lens corresponds to the human left eye. In other words, in a case where an image from the left lens of the twin-lens camera is output as a left-eye image, and an image from the right lens is output as a right-eye image, a VR image cannot be correctly viewed stereoscopically because the horizontal parallax is reversed.

In VR imaging, it may be difficult to horizontally fix the twin-lens camera depending on a situation, such as imaging using a drone, low-angle imaging using a tripod, and imaging with a camera fixed onto the ceiling. Furthermore, a twin-lens camera may be fixed upside down, that is, in a state (attitude) rotated by 180 degrees. In a case where the rotational shift is corrected using the rotational shift correction parameter recorded in the camera and a horizontal image is output, a VR image may be output in which the horizontal parallax is reversed, as described above.

### SUMMARY

An image processing apparatus according to one aspect of the disclosure includes a memory storing instructions, and a processor configured to execute the instruction to acquire a first image and a second image with parallax, or one image including the first image and the second image, output one stereoscopic viewable image by setting the first image as a right-eye image and the second image as a left-eye image in a first mode, and output one stereoscopic viewable image by setting the first image as the left-eye image and the second image as the right-eye image, and by rotating the first image and the second image around an optical axis in a second mode. An image pickup apparatus including the above image processing apparatus also constitutes another aspect of the disclosure. An image processing method corresponding to the above image processing apparatus also constitutes another aspect of the disclosure. A storage medium storing a program that causes a computer to execute the above image processing method also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a sectional view of a lens apparatus according to this embodiment.

FIG. 2 is a block diagram of an image pickup apparatus according to this embodiment.

FIG. 3 illustrates an example image captured by the image pickup apparatus according to this embodiment.

FIGS. 4A and 4B illustrate example images obtained by converting the image in FIG. 3 using an equidistant cylindrical projection method.

FIGS. 5A, 5B, and 5C are example configuration diagrams and an image captured by the image pickup apparatus according to this embodiment.

FIGS. 6A and 6B are example images obtained by converting the image in FIG. 5C using the equidistant cylindrical projection method.

FIGS. 7A and 7B are examples of a front view and an image captured by the image pickup apparatus in an upside-down attitude according to this embodiment.

FIGS. 8A, 8B, and 8C are example images obtained by converting the image in FIG. 7B using the equidistant cylindrical projection method.

FIGS. 9A, 9B, and 9C are configuration examples of the image processing apparatus (application) according to this embodiment.

FIGS. 10A and 10B are examples of a front view and an image captured by the image pickup apparatus in the upside-down imaging mode and tilted around the optical axis according to this embodiment.

FIGS. 11A, 11B, and 11C are example images obtained by converting captured images according to this embodiment using the equidistant cylindrical projection method.

FIG. 12 is a flowchart of an image pickup method according to this embodiment.

FIGS. 13A and 13B are example operation screens of the image processing apparatus according to this embodiment.

FIGS. 14A and 14B are side views of the image pickup apparatus in an upward attitude according to this embodiment.

FIGS. 15A and 15B are example live-view images of the image pickup apparatus according to this embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

A lens apparatus (interchangeable lens) according to this embodiment includes two optical systems (a first optical system and a second optical system) arranged in parallel (symmetrically) with each other, and is configured so that two image circles are imaged in parallel on a single image sensor. These two optical systems are arranged horizontally and spaced apart by a predetermined distance (base length). When viewed from the image side, an image formed by the right optical system (first optical system) is recorded as a moving or still image for the right eye, and an image formed by the left optical system (second optical system) is recorded as a moving or still image for the left eye. In viewing a played-back moving or still image using a known three-dimensional display unit or so-called VR goggles, the user's right eye views the right-eye image, and the left eye views the left-eye image. At this time, images with parallax are projected to the right and left eyes due to the base length of the lens apparatus, so the user can obtain a three-dimensional sense. Thus, the lens apparatus according to this embodiment is a lens apparatus for stereoscopic imaging that can form two images with parallax using the first and second optical systems.

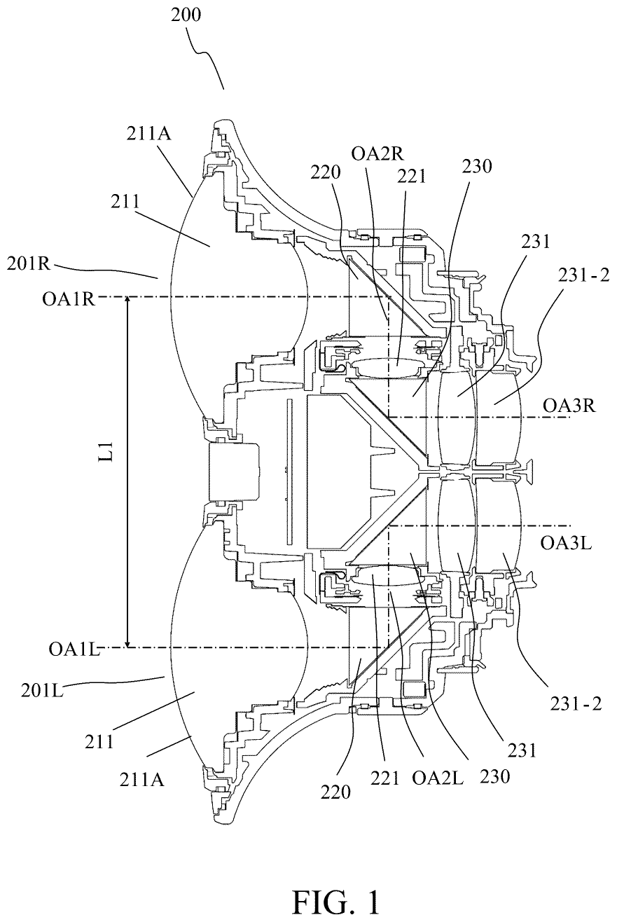

Referring to FIG. 1, a description will be given of an interchangeable lens (lens apparatus) 200 according to this embodiment. FIG. 1 is a sectional view illustrating a schematic configuration of the first optical system 201R and the second optical system 201L of the interchangeable lens 200. The interchangeable lens 200 includes the first optical system 201R and the second optical system 201L. Each of the first optical system 201R and the second optical system 201L can perform imaging at an angle of view of 180 degrees or more. Each optical system has, in order from the object side to the image side, a first optical axis OA1, a second optical axis OA2 approximately orthogonal to the first optical axis, and a third optical axis OA3 parallel to the first optical axis OAL. Along each optical axis, a first lens 211 having a convex surface 211A on the object side is disposed on the first optical axis OA1, a second lens 221 is disposed on the second optical axis OA2, and third lenses 231 and 231-2 are disposed on the third optical axis OA3. Each optical system further includes a first prism 220 configured to bend a light beam on the first optical axis OA1 and guide it to the second optical axis OA2, and a second prism 230 configured to bend a light beam on the second optical axis OA2 and guide it to the third optical axis OA3. A first optical axis OA1R of the first optical system 201R and a first optical axis OA1L of the second optical system 201L are separated from each other by a base length L1, and can capture images with parallax corresponding to the base length L1.

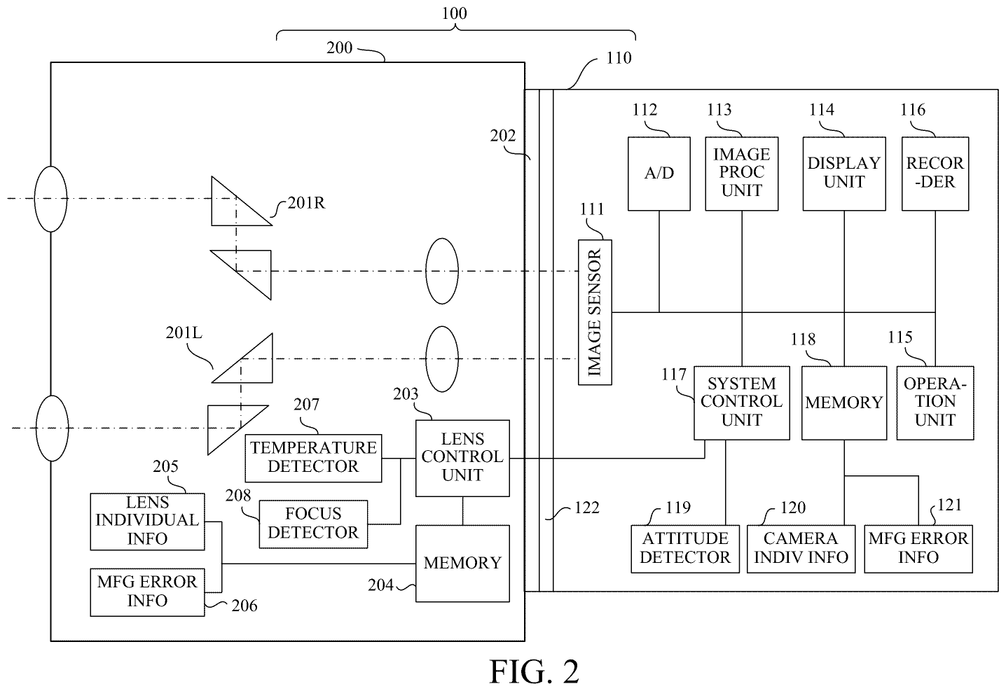

FIG. 2 is a block diagram of the image pickup apparatus 100 that can capture a stereoscopic image. As illustrated in FIG. 2, the image pickup apparatus 100 includes a camera body 110 and an interchangeable lens 200. The interchangeable lens 200 is attached to and used with the camera body 110. In this embodiment, the interchangeable lens 200 is an interchangeable lens system that is attachable to and detachable from the camera body 110, but the camera body and the lens apparatus may be integrated with each other.

The interchangeable lens 200 includes the first optical system 201R and the second optical system 201L that constitute an imaging optical system, and form images on the image sensor 111 of the camera body 110. A lens control unit (LENS CTRL) 203 of the interchangeable lens 200 processes values detected by various detectors such as a temperature (TEMP) detector 207 and a focus detector 208, outputs processed information to the system control unit 117, communicates it with the camera body 110, and controls the image pickup apparatus 100 in cooperation with the camera body 110. The interchangeable lens 200 further includes a memory (storage unit) 204. The memory 204 stores various information detected by the temperature detector 207 and the focus detector 208, and outputs identification information such as lens individual information 205 or manufacturing (MFG) error information 206 to a system control unit 117 in response to a request from the system control unit 117.

The camera body 110 includes an image sensor 111, an A/D converter 112, an image processing (PROC) unit 113, a display unit 114, an operation unit 115, a recorder 116, a system control unit 117, an attitude detector 119, and a camera mount 122. In a case where the interchangeable lens 200 is attached to the camera body 110 via a lens mount 202 and the camera mount 122, the system control unit 117 and the lens control unit 203 are electrically connected.

As object images a right-eye image formed through the first optical system 201R and a left-eye image formed through the second optical system 201L are formed on the image sensor 111 side by side. The image sensor 111 converts the formed object images (optical signals) into analog electrical signals. The A/D converter 112 converts the analog electrical signals output from the image sensor 111 into digital electrical signals (image signals). The image processing unit 113 performs various image processing for the digital electrical signals (image signals) output from the A/D converter 112.

The display unit 114 displays various information. The display unit 114 is realized, for example, by an electronic viewfinder or a liquid crystal panel. The operation unit 115 has a function as a user interface for a user to issue instructions to the image pickup apparatus 100. In a case where the display unit 114 has a touch panel, the touch panel also serves as part of the operation unit 115.

The recorder 116 records various data such as image data that has received image processing by the image processing unit 113. The recorder 116 also stores programs. The recorder 116 is realized, for example, by ROM, RAM, and HDD.

The memory 118 stores individual identification information such as camera individual information 120 and camera manufacturing error information 121 of the image pickup apparatus 100. In the manufacturing process of the camera body 110, the memory 118 stores information including, for example, model type information of the camera body 110, pixel number information of the image sensor 111, physical size information of the image sensor 111, manufacturing error information on captured images, etc. In imaging using the image pickup apparatus 100, the memory 118 outputs the above identification information to the system control unit 117. Then, together with the identification information on the interchangeable lens 200 sent from the lens control unit 203 in the interchangeable lens 200, the identification information is generated as an image. This image (information image) is output to the image processing unit 113, added to the captured image, and recorded in imaging data. As described above, the image processed by the image processing unit 113 can be written to various storage media, such as a flash memory or an HDD, by the recorder 116.

The system control unit 117 centrally controls the entire image pickup apparatus 100. The system control unit 117 is realized by using a CPU, for example. These pieces of information are recorded on a medium by the recorder 116 via the system control unit 117. On the other hand, the light taken by the imaging optical system images on the image sensor 111. Generally, a formed image is captured by an image sensor 111, subject to various processing by the A/D converter 112 and image processing unit 113, and then written as a captured image.

A description will now be given of example fisheye images captured with the image pickup apparatus 100 and example images converted into the equidistant cylindrical projection method. In a case where an image is captured with an image pickup apparatus having a single general lens optical system, an image that is inverted by 180 degrees is formed on the image sensor. In converting this image into a normal image, 180-degree inversion processing is performed to adjust the vertical direction.

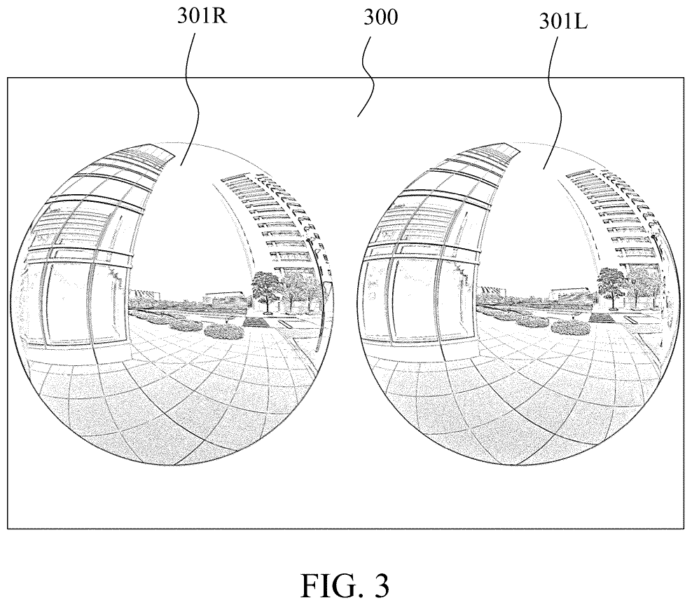

FIG. 3 illustrates an example image captured by the image pickup apparatus 100. Images (for example, image 300) captured through the interchangeable lens 200 are imaged on the single image sensor 111 through a first optical system 201R corresponding to the right eye and a second optical system 201L corresponding to the left eye in normal imaging, and inverted by 180 degrees for each optical system. In order to adjust the top and bottom of the captured images, the entire captured image is inverted by 180 degrees, similarly to a general optical system. At this time, the image 300 is output in which an imaging result (right-eye fisheye image 301R) of the first optical system corresponding to the right eye in normal imaging is captured on the left side of the captured image, and an imaging result (left-eye fisheye image 301L) of the second optical system corresponding to the left eye in normal imaging is captured on the right side of the captured image.

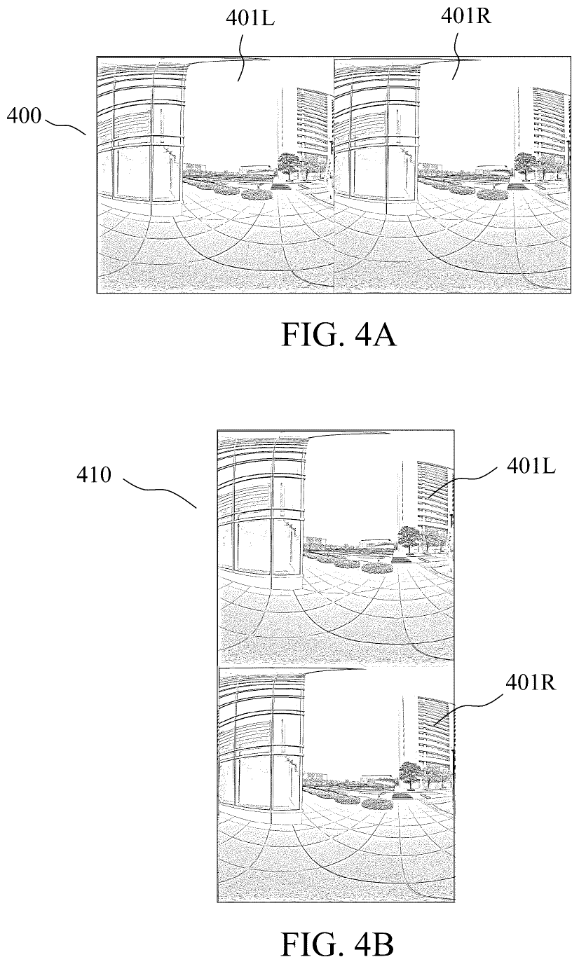

FIGS. 4A and 4B illustrate an example in which the image 300 in FIG. 3 is converted into an image of an equidistant cylindrical projection method (“equidistant cylindrical projection image” hereinafter). Generally, as illustrated in FIG. 4A, an image 400 is formed in which a left-eye equidistant cylindrical projection image 401L and a right-eye equidistant cylindrical projection image 401R are arranged side by side, and can be displayed on a VR device, such as an HMID. Alternatively, as illustrated in FIG. 4B, an image 410 may be formed in which the left-eye equidistant cylindrical projection image 401L at the top and the right-eye equidistant cylindrical projection image 401R at the bottom. Here, the imaging data includes lens individual information 205 and manufacturing error information 206, and based on the lens individual information 205 and manufacturing error information 206, fisheye imaging data (image 300) of FIG. 3 can be converted into an equidistant cylindrical projection image (image 400).

The HMID can determine whether an image is a left-eye image or a right-eye image based on a fixed layout such as a horizontal arrangement or a vertical arrangement, and can display each image on a left-eye or right-eye display position of the HMD. Depending on the image player in the HMID, the user may be able to set left and right displays. The user also enables the HMID to directly read the fisheye image (image 300). In that case, mesh data may be linked as metadata to a fisheye image in the image, and the image may be displayed on the HMD in accordance with the mesh data. The mesh data includes a mesh projected onto a virtual sphere, and is transformed coordinate information in which coordinates on the virtual sphere are associated with center coordinates and peripheral coordinates of the fisheye image. This method adds metadata to an image such that the left-eye fisheye image 301L is associated with a left-eye mesh, and the right-eye fisheye image 301R is associated with a right-eye mesh. The mesh data including the lens individual information 205 and manufacturing error information 206 can provide a more accurate and correct VR display. As described above, regardless of whether it is a fisheye image or an equidistance cylindrical projection image, setting a left-eye image and a right-eye image based on the image arrangement and mesh data enables the images to be VR-displayed on the HMD.

Here, the VR display (VR view) is a display method (display mode) that can change a display range for displaying an image in a viewing range of the VR image according to the attitude (or orientation) of the display apparatus. VR display includes “single-lens VR display (single-lens VR view)” for displaying a single image by performing a transformation that maps a VR image onto a virtual sphere (for distortion correction). VR display further includes “twin-lens VR display (twin-lens VR view)” for performing transformation that maps a left-eye VR image and a right-eye VR image onto virtual spheres and for displaying them side by side in left and right areas. Stereoscopic viewing can be provided by the “twin-lens VR display” using a left-eye VR image and a right-eye VR image that have parallax with each other.

In any type of VR display, for example, in a case where a user wears a display apparatus such as an HMD, an image is displayed in a viewing range that corresponds to the orientation of the user's face. For example, assume that at a certain time in a VR image, an image is displayed with a viewing range centered at 0 degrees horizontally (a specific direction, e.g., north) and 90 degrees vertically (90 degrees from the zenith, i.e., horizontal direction). In a case where the attitude of the display apparatus is reversed from this state (for example, by changing the display surface from south to north), the display range of the same VR image is changed to an image with a viewing range of 180 degrees in the horizontal direction (opposite direction, for example, south), and 90 degrees in the vertical direction. That is, when the user turns his/her face from north to south (that is, turns backward) while wearing the HMD, the image displayed on the HMD is also changed from the north image to the south image. A VR image captured with the interchangeable lens 200 according to this embodiment includes a VR 180 image obtained by capturing the front in a range of approximately 180 degrees, and does not include an image in a range of approximately 180 degrees in the rear. In a case where this VR 180 image is VR-displayed and the attitude of the display apparatus is changed to the side where no image exists, a blank area is displayed.

By VR-displaying a VR image in this way, the user visually feels as if he is inside the VR image (inside the VR space). The VR image displaying method is not limited to the method of changing the attitude of the display apparatus. For example, the display range may be moved (scrolled) in response to a user operation via a touch panel, a directional button, or the like. Moreover, during VR display (in the “VR View” display mode), in addition to changing the display range due to the attitude change, the display range may be changed in response to touch moves on the touch panel, drag operation with a mouse, etc., pressing a directional button, etc. A smartphone attached to VR goggles (head mount adapter) is one type of HMD.

Normally, imaging using an image pickup apparatus capable of three-dimensional imaging, such as the image pickup apparatus 100, requires two lenses to be fixed or held so that they are horizontally arranged. In a case where fisheye images captured in an accurately horizontal state are converted to equidistant cylindrical projection images or mesh data is embedded, and a user views them as the VR images displayed on an HMD, he can enjoy excellent VR viewing.

However, in a case where image processing similar to that described above is performed for an image captured while the image pickup apparatus 100 was slightly tilted during imaging and the image is VR-displayed on an HMD, even if the attitudes of the viewer and the HMD are correct, the VR-displayed image is tilted by the tilt amount during imaging. As a result, the attitude of the viewer and the attitude of the VR display are different, and the viewer is likely to experience a phenomenon called VR sickness, which causes sickness due to mismatched senses.

Accordingly, the image pickup apparatus 100 according to this embodiment includes the attitude detector 119 configured to detect the attitude of the image pickup apparatus 100 during imaging and output attitude data, and the image pickup apparatus 100 can detect the tilt during imaging and correct it horizontally. The attitude detector 119 is, for example, an acceleration sensor or a gyro sensor. The image pickup apparatus 100 acquires the attitude data (tilt correcting value (horizontal correcting value or horizontalization value)) obtained from the attitude data) from the attitude detector 119. The attitude data is embedded in the imaging data and linked to the imaging data. In converting a captured image into an equidistant cylindrical projection image, the image pickup apparatus 100 performs correction using the attitude data in addition to the lens individual information 205 and the manufacturing error information 206, and outputs a horizontally corrected VR image.

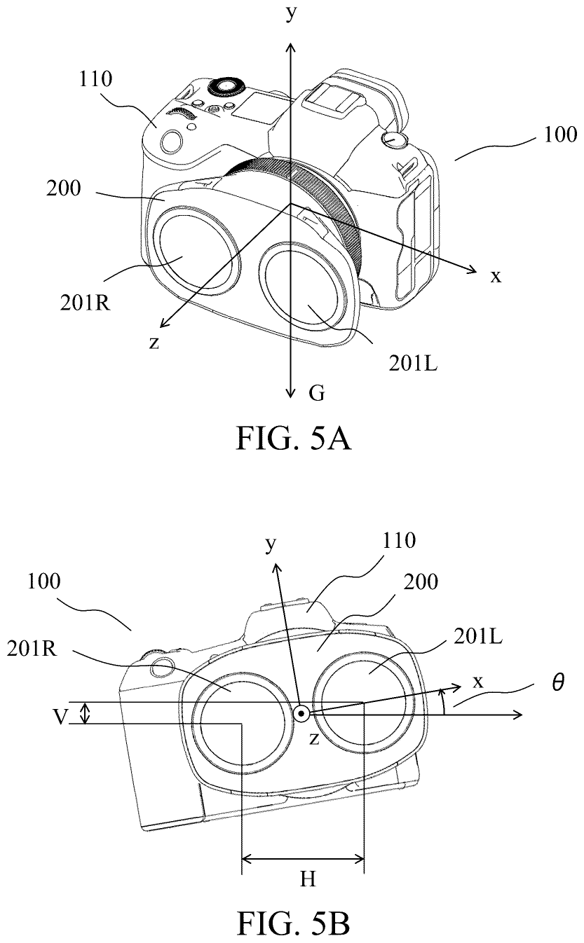

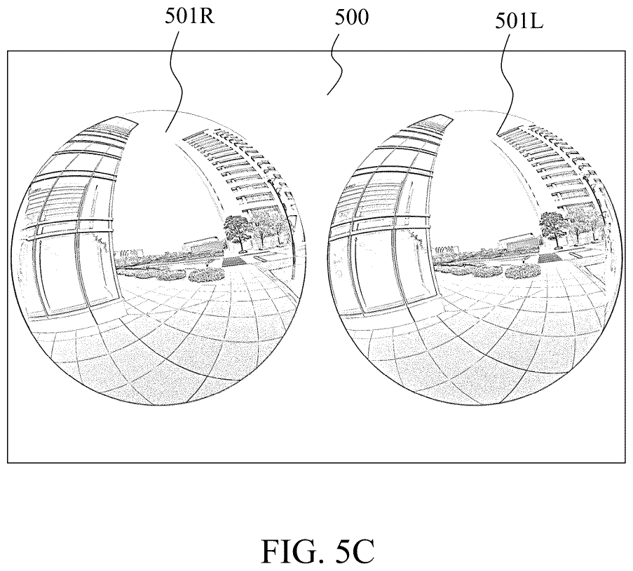

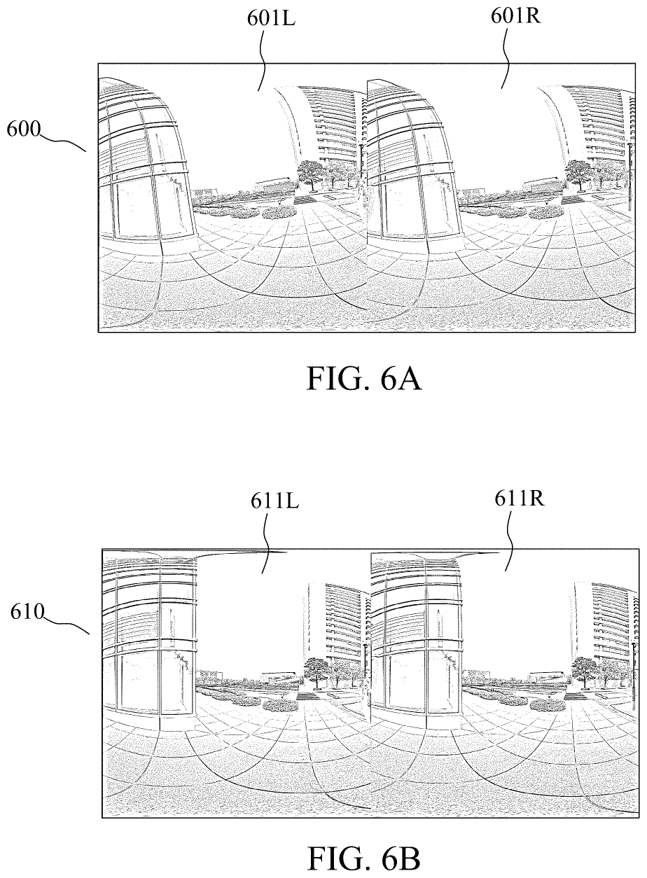

FIGS. 5A, 5B, and 5C are configuration diagrams of the image pickup apparatus 100 and an example captured image. For example, as illustrated in FIG. 5A, assume that an x-axis is a horizontal direction of the twin-lens image pickup apparatus 100 having two optical systems, i.e., the first optical system 201R and the second optical system 201L, a y-axis is a vertical direction, and a z-axis is a depth direction. As illustrated in FIG. 5B where the image pickup apparatus 100 is viewed from the front, in a case where imaging is performed in a tilted state at an angle θ from the horizontal direction in a rotation direction around the z-axis (roll direction), an image (captured image) 500 illustrated in FIG. 5C is output. That is, in the image (captured image) 500, a fisheye image 501R captured with the first optical system 201R and a fisheye image 501L captured with the second optical system 201L are output as captured images tilted by the angle θ. The angle θ can be calculated by detecting the gravity direction G using the attitude detector 119 such as an acceleration sensor provided in the image pickup apparatus 100, for example. In a case where this image is converted into an equidistant cylindrical projection image, as illustrated in FIG. 6A, the output image 600 includes tilted equirectangular images 601R and 601L as a VR image.

Here, the attitude of the image pickup apparatus 100 is detected by the attitude detector 119 such as an acceleration sensor, and attitude data indicating that the image pickup apparatus 100 is tilted by an angle θ in the roll direction is written as metadata in the image 500. By performing correction based on this attitude data, an image 610 is output as a VR image that includes horizontally corrected equirectangular cylinder images 611R and 611L, as illustrated in FIG. 6B. This tilt correction (horizontalization or horizontal correction) is performed simultaneously in converting the image 500 into an equidistant cylindrical projection image, and the image 610 can be output from the image 500. Viewing the thus horizontally corrected image on the HMD can suppress VR sickness.

In the case of mesh data, linking information that it is tilted by an angle θ in a roll direction as metadata can correct the image by the angle θ in the roll direction and VR-display it on an HMD. However, in a case where the angle θ is large, not only horizontal parallax H but also vertical parallax V occur, as illustrated in FIG. 5B. The horizontal parallax H is also smaller than the base length L1 as the parallax in the horizontal state. Moreover, in a case where the attitude of the image pickup apparatus 100 is tilted by 90 degrees in the roll direction, the horizontal parallax H becomes zero, and in a case where it is tilted by an angle more than 90 degrees, the horizontal parallax H becomes a parallax in the opposite direction.

In the image 610 illustrated in FIG. 6B that has been horizontally corrected based on the attitude data, the tilt in the roll direction has been corrected, but the vertical parallax remains in this image due to the vertical parallax V In a case where the vertical parallax is small, VR sickness may not occur, but as the vertical parallax increases, the user is more likely to feel VR-sick, so the object may be held as horizontally as possible during imaging.

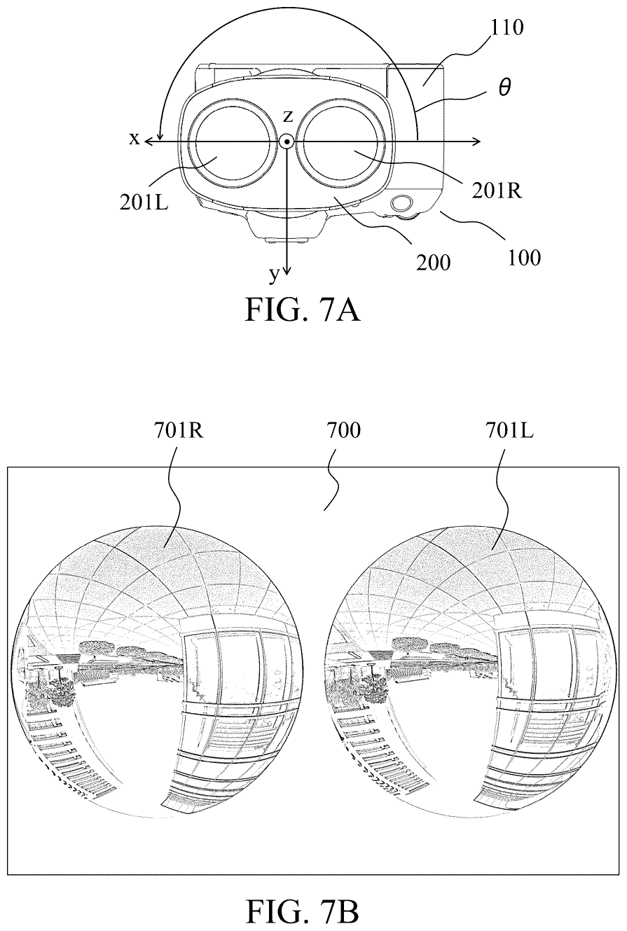

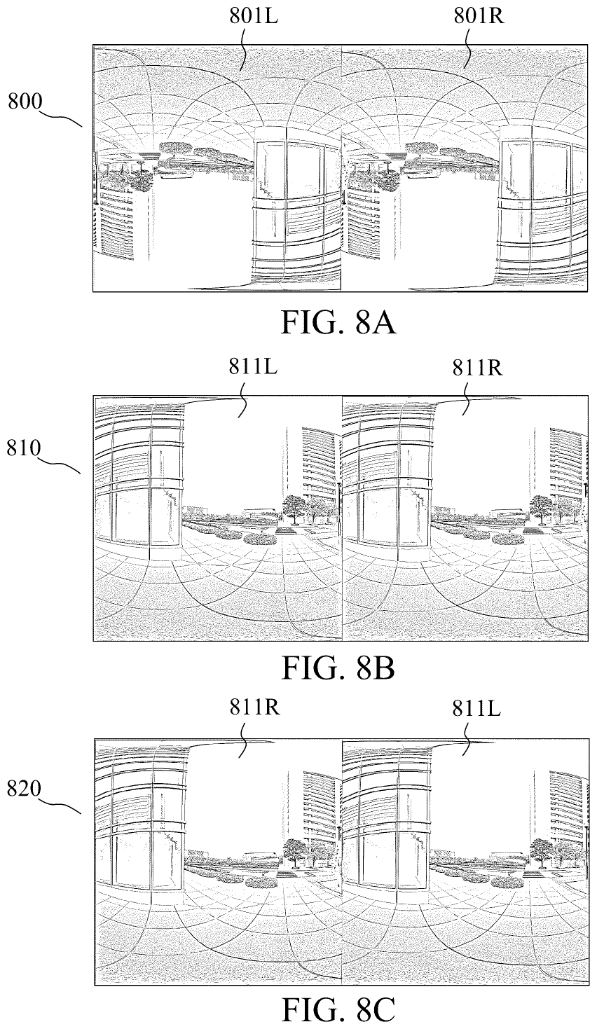

Referring now to FIGS. 7A to 8C, a description will be given of imaging while the image pickup apparatus 100 is held in an upside-down state (upside-down attitude). FIGS. 7A and 7B are examples of a front view and an image captured by the image pickup apparatus in an upside-down attitude. FIGS. 8A, 8B, and 8C are examples of images obtained by converting the image in FIG. 7B using the equidistant cylindrical projection method.

Imaging in the state illustrated in FIG. 7A at an angle θ of 180 degrees in the roll direction provides an upside-down image (captured image) 700 illustrated in FIG. 7B. In a case where the image 700 is directly converted into an equidistant cylindrical projection image, an upside-down image (VR image) 800 illustrated in FIG. 8A is output. Similarly, in a case where the angle θ in the roll direction is corrected to 180 degrees based on the attitude data, a horizontally corrected image 810 illustrated in FIG. 8B is output. Here, a corrected image 811L is an image obtained by correcting the rotation of the image 801L by 180 degrees, and a corrected image 811R is an image obtained by correcting the rotation of the image 801R by 180 degrees. However, these corrections cause the horizontal parallax to be reversed.

That is, in order to stereoscopically view the images captured in the attitude illustrated in FIG. 7A with the correct attitude and parallax, the first optical system 201R is to be used for a left-eye image, and the second optical system 201L is to be used for a right-eye image. However, in a case where the tilt of the image is corrected (the image is horizontalized) using a similar algorithm, the image 701R captured by the first optical system 201R is output as an image 801R in the image 800 converted by the equidistant cylindrical projection method. Further, it is output as an image 811R in the image 810 that has been rotationally corrected by 180 degrees, and is used as a right-eye image. Similarly, the image captured by the second optical system 201L is output as an image 801L in the image 800 converted by the equidistant cylindrical projection method. Further, it is output as an image 811L in the image 810 that has been rotationally corrected by 180 degrees, and is used as a left-eye image.

In other words, the image 400 captured in a normal attitude and converted to an equidistant cylindrical projection image, and the image 810 captured in an upside-down attitude, rotationally corrected by 180 degrees, and converted to an equidistant cylindrical projection image are images in which the left and right are reversed. In order to obtain a VR image with correct parallax, as in an image 820, an image 811R obtained by correcting the rotation of the image 801R by 180 degrees is to be used for the left eye, and an image 811L obtained by correcting the rotation of the image 801L by 180 degrees is to be used for the right eye.

In this way, one specific algorithm that performs rotational correction by 180 degrees, exchanges left-eye and right-eye images, and outputs the result is a method for rotationally correcting the image 801R by 180 degrees and placing the result on the left side of the image 820, and for rotationally correcting the image 801L by 180 degrees and placing the result on the right side of the image 820. Another method is to regard the pre-correction image 800 as a single image, to rotate the entire image 800 by 180 degrees, and to output the image 820. The image processing described above can be performed simultaneously with processing of converting the image 700 into an equidistant cylindrical projection image, and the image 820 can be output from the image 700.

In linking mesh data to a fisheye image, the image 701R is linked to data indicating that it is a right-eye image, and the image 701L is linked to data that it is a left-eye image. Data indicating that the image is rotated by 180 degrees in the roll direction is also linked. Even when the image is to be corrected by 180 degrees in the roll direction and displayed, data that the image 701R is a right-eye image and the image 701L is a left-eye image are maintained and they are displayed on the HMD with the reversed parallax. In other words, in order to convert a VR image that includes a left-eye image and a right-eye image and has been captured upside down into an image viewable in the correct attitude, the rotational correction by 180 degrees and exchanging the left-eye image and the right-eye image are required. In other words, the data that the image 701R is a left-eye image and the image 701L is a right-eye image are to be written.

Accordingly, the image pickup apparatus 100 according to this embodiment has a normal imaging mode (first mode) and an upside-down imaging mode (second mode). In the normal imaging mode, for example, an image captured by the first optical system 201R is output as a right-eye image, and an image captured by the second optical system 201L is output as a left-eye image. In the upside-down imaging mode, an image captured by the first optical system 201R is output as a left-eye image, and an image captured by the second optical system 201L is output as a right-eye image.

The image processing apparatus according to this embodiment runs on an application (software) that supports still and moving images captured with a digital camera (image pickup apparatus) including a twin-lens (VR180 lens), and is typically realized by a terminal, such as a personal computer (PC) or a smartphone. The above application may be installed in the digital camera.

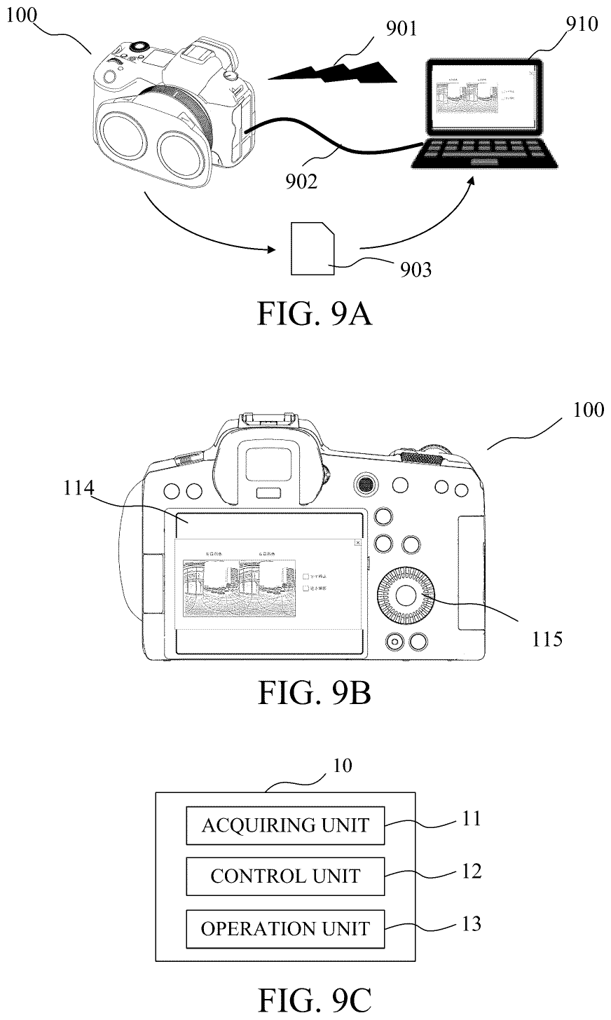

Referring now to FIGS. 9A, 9B, and 9C, a description will be given of a configuration example of the image processing apparatus (application) according to this embodiment. FIGS. 9A and 9B are configuration examples of the image processing apparatus (application). FIG. 9C is a block diagram of the image processing apparatus.

In the configuration illustrated in FIG. 9A, image data captured by the image pickup apparatus 100 is transmitted to a terminal 910 such as a PC, a smartphone, or a tablet via a wireless communication 901 such as WIFI or Bluetooth (registered trademark), or a cable (wire) 902. Alternatively, the imaging data stored in the memory card 903 can be loaded by the terminal 910. The configuration is to output a VR image using the application (image processing apparatus) installed on the terminal 910.

In the configuration illustrated in FIG. 9B, the application (image processing apparatus) is installed in the image pickup apparatus 100, and operable by the operation unit 115 to output a VR image from imaging data, display it on the display unit 114, and record it on a medium through the recorder 116.

As illustrated in FIG. 9C, the image processing apparatus 10 according to this embodiment includes an acquiring unit 11, a control unit 12, and an operation unit 13. The acquiring unit 11 acquires a first image and a second image with parallax, or a single image including the first and second images with parallax. The control unit 12 can set a first mode and a second mode. In the first mode, the control unit 12 outputs a single stereoscopic viewable image (equidistant cylindrical projection image) by setting the first image as a right-eye image and the second image as a left-eye image. In the second mode, the control unit 12 outputs a single stereoscopic viewable image by setting the first image as a left-eye image and the second image as a right-eye image, and by setting each of the first and second images as an image rotated by 180 degrees around the optical axis. The operation unit 13 is operable by the user, but is not essential according to this embodiment. The control unit 12 can set the first mode and the second mode according to the user's selection. However, this embodiment is not limited to this example, and the control unit 12 may set the first mode and the second mode based on a predetermined condition that does not depend on the user's selection.

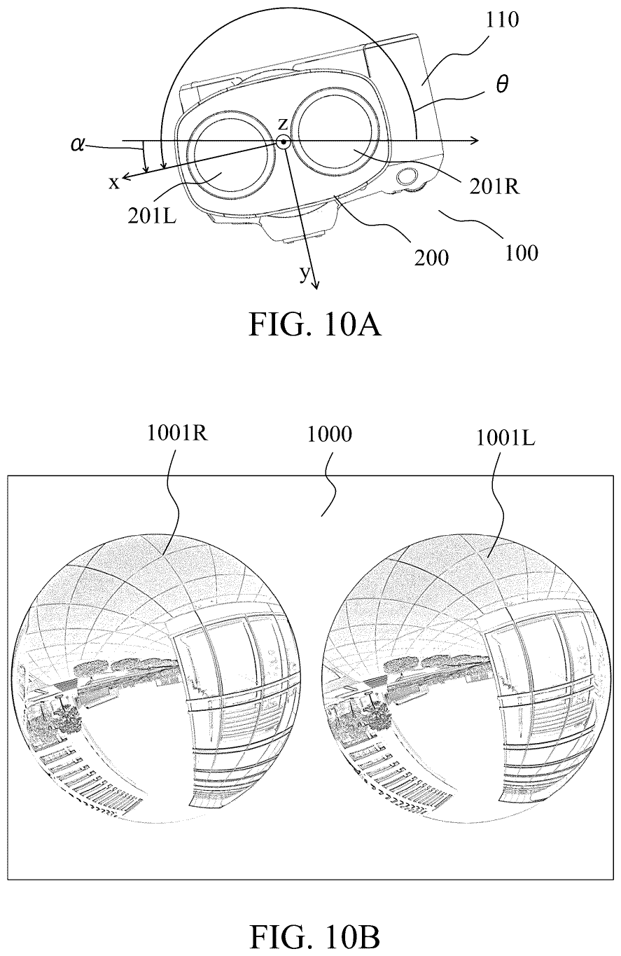

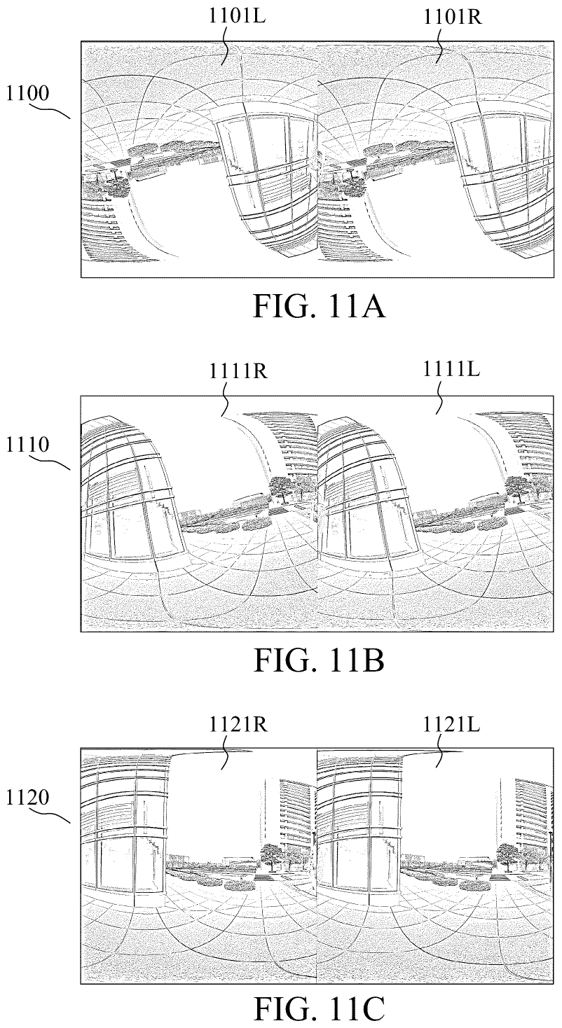

Referring now to FIGS. 10A to 11C, a description will be given of correcting a slight tilt of the image pickup apparatus 100 in the upside-down imaging mode.

FIGS. 10A and 10B are a front view and an example of a captured image of the image pickup apparatus 100 tilted around the optical axis in the upside-down imaging mode, respectively. FIGS. 11A, 11B, and 11C illustrate examples of images obtained by converting the captured image using the equidistant cylindrical projection method.

As illustrated in FIG. 10A, assume an image captured by the image pickup apparatus that has an attitude in the upside-down imaging mode where the first optical system 201R is set to the left eye and the second optical system 201L is set to the right eye, and is tilted by an angle α. In other words, the image is captured with the attitude rotated at an angle θ=180° from the horizontal state and in the +α roll direction. In this case, as illustrated in FIG. 10B, an image 1000 is obtained that is approximately upside down and tilted by the angle α. In a case where the image 1000 is directly converted into an equidistant cylindrical projection image, a VR image 1100 is output that is approximately upside down and tilted by α, as illustrated in FIG. 11A.

Since the attitude illustrated in FIG. 10A is approximately upside down, an image captured by the first optical system 201R is to be output as a left-eye image and an image captured by the second optical system 201L is to be output as a right-eye image. Therefore, in a case where the rotation is corrected by 180 degrees in the roll direction in the upside-down imaging mode, an image 1110 illustrated in FIG. 11B is output. That is, the image 1110 is output by setting an image 1111R obtained by correcting the image 1101R by 180 degrees as a left-eye image, and an image 1111L obtained by correcting the image 1101L by 180 degrees as a right-eye image.

However, if only the 180° rotation correction is performed in the upside-down imaging mode, the image is still tilted by the angle α. Accordingly, in order to create a VR viewable image in the correct attitude, the rotation of the angle α is to be corrected to create a horizontal VR image. Simply applying the conventional tilt correcting (horizontalizing) algorithm does not properly work. This is because the imaging data captured in the attitude illustrated in FIG. 10A contains the attitude data detected by the attitude detector 119, and the attitude data includes attitude information indicating that the image is tilted at an angle θ in the roll direction. Here, if the conventional tilt correcting algorithm is simply applied to correct the tilt of the image 1110, the angle θ is corrected in the roll direction. In order to correctly horizontalize and output an image 1120 illustrated in FIG. 11C, horizontalization by the angle α, which is obtained by subtracting 180 degrees from the angle θ, in the roll direction is to be performed.

For easy understanding, the upside-down conversion in the upside-down imaging mode and tilt correction in addition to the upside-down conversion have been hitherto described in order, but this embodiment is not limited to this example. In correcting the tilt in the upside-down imaging mode, for example, simultaneous processing is achieved in converting the image 1000 to an equidistant cylindrical projection image, and the image 1120 can be output from the image 1000.

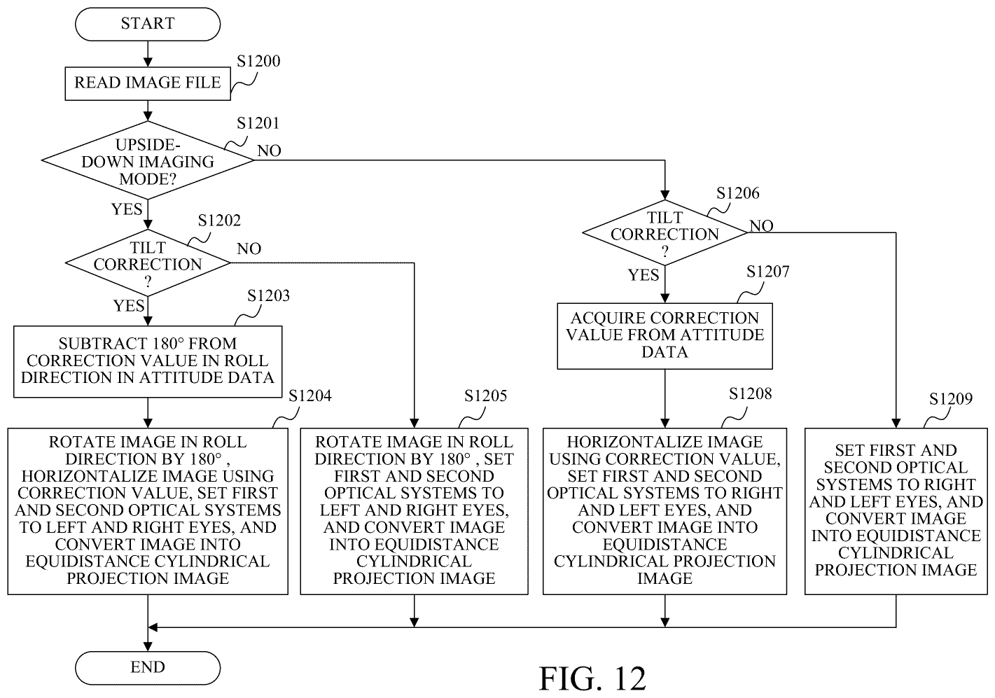

Referring now to FIG. 12, a description will be given of an image pickup method using an image processing apparatus having an upside-down imaging mode and a tilt correcting function according to this embodiment. FIG. 12 is an example of a flowchart illustrating an image pickup method according to this embodiment.

First, in step S1200, the image processing apparatus (application) reads an image file. The images read here are fisheye images such as images 300, 500, 700, and 1000. At this time, attitude data and imaging information included in the image are also read as metadata.

Next, in step S1201, the image processing apparatus determines whether the image read in step S1200 is an image captured in the upside-down imaging mode (whether the image was captured in the normal imaging mode or the upside-down imaging mode). Here, a method for determining the upside-down imaging mode may be selected by the user using the operation unit in the image processing apparatus, or may be automatically determined by an application based on image information. The method for determining the upside-down imaging mode will be described later.

In a case where it is determined in step S1201 that the mode is upside-down imaging mode, the flow proceeds to step S1202. In step S1202, the image processing apparatus determines whether tilt correction is to be performed.

Similarly, the determination of tilt correction may be selectable by the user using the operation unit of the image processing apparatus, or automatically determined by an application based on image information.

In a case where it is determined in step S1202 that tilt correction is to be performed, the flow proceeds to step S1203. In step S1203, since tilt correction is further performed in the upside-down imaging mode, the correction value in the roll direction in the attitude data is to be a value subtracted by 180°, as described above. Next, in step S1204, the image processing apparatus performs tilt correction using the correction value in the roll direction, which has been adjusted to a value subtracted by 180°. Since the image processing apparatus is in the upside-down imaging mode, the image is converted to an equidistant cylindrical projection image (stereoscopic viewable image) by rotating the image by 180 degrees in the roll direction, and by setting the image from the first optical system 201R as a left-eye image and the image from the second optical system 201L as a right-eye image. In this embodiment, a rotation correcting angle around the optical axis for an input image of a stereoscopic viewable image that has been horizontalized in the normal imaging mode, and a rotation correcting angle around the optical axis for an input image of a stereoscopic viewable image that has been horizontalized in the upside-down imaging mode are different from each other by 180 degrees.

By using the algorithm described above in steps S1203 and S1204, the tilt correcting algorithm and the algorithm that processes in upside-down imaging mode can be used as they are by simply changing the argument for the correction value in the roll direction to a value subtracted by 180 degrees.

Another solution in the tilt correction in the upside-down imaging mode is to output an equidistant cylindrical projection image by performing the tilt correction using a roll correcting value higher than 180°, and by setting the image from the first optical system 201R as the left-eye image and the image from the second optical system 201L as the right-eye image. However, this case requires two algorithms for the upside-down imaging mode, because the algorithm itself for the upside-down imaging mode changes depending on whether tilt correction is performed or not. In other words, in a case where tilt correction is to be performed, since the tilt correction processing provides a correct attitude, rotation in the roll direction by 180 degrees is not required for the upside-down imaging mode. On the other hand, in a case where no tilt correction is to be performed, rotation in the roll direction by 180 degrees is required for the upside-down imaging mode to obtain the correct attitude.

In a case where it is determined in step S1202 that tilt correction is not to be performed, the flow proceeds to step S1205. In step S1205, the image processing apparatus rotates the image by 180 degrees in the roll direction, sets the image from the first optical system 201R as the left-eye image and the image from the second optical system 201L as the right-eye image without using the correction value, and converts the image into an equidistant cylindrical projection image.

Both of steps S1204 and S1205 are in the upside-down imaging mode, and thus the images are rotated by 180 degrees in the roll direction, and the image from the first optical system 201R is set as the left-eye image, and the image from the second optical system 201L is set as the right-eye image, and these images are output. During this processing, the left-eye image and the right-eye image may be processed and pasted together to output a final equidistant cylindrical projection image. Alternatively, an algorithm similar to that for the normal imaging mode may be used to create laterally arranged equidistant cylindrical projection images, to regard them as a single image, to rotate the entire image by 180 degrees, and then output a final equidistant cylindrical projection image. Based on the image captured in the upside-down imaging mode, the image processing apparatus according to this embodiment may ultimately output the image from the first optical system 201R as the left-eye image and the image from the second optical system 201L as the right-eye image, which are rotated by 180 degrees in the roll direction. As long as such a result can be obtained, any processing may be performed within the algorithm for images captured in the upside-down imaging mode.

In a case where it is determined in step S1201 that it is not the upside-down imaging mode, the flow proceeds to step S1206. In step S1206, the image processing apparatus determines whether tilt correction is to be performed, similarly to step S1202. In a case where it is determined that tilt correction is to be performed, the flow proceeds to step S1207. In step S1207, the image processing apparatus obtains attitude data included in the image and obtains a correction value. Next, in step S1208, the image processing apparatus horizontally corrects the image using the obtained correction value, and sets the image from the first optical system 201R as a right-eye image and the image from the second optical system 201L as a left-eye image, and convert the image into an equidistant cylindrical projection image.

In a case where it is determined in step S1206 that tilt correction is not to be performed, the flow proceeds to step S1209. In step S1209, the image processing apparatus sets the image from the first optical system 201R as a right-eye image and the image from the second optical system 201L as a left-eye image and converts these images into equidistant cylindrical projection images.

As described above, the application runs on the algorithm flowchart according to this embodiment.

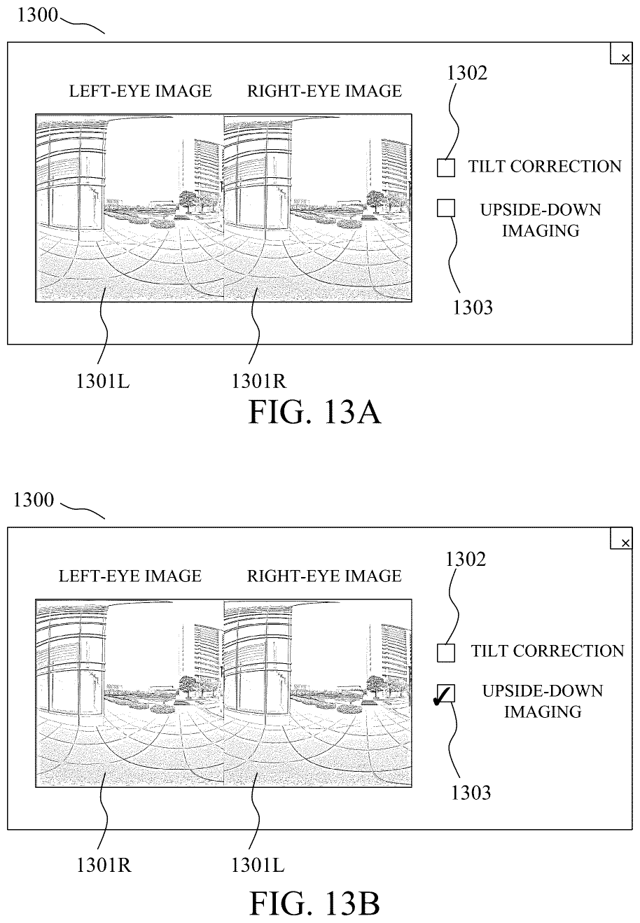

Referring now to FIGS. 13A and 13B, a description will be given of the operation screen of the image processing apparatus (application) according to this embodiment. FIGS. 13A and 13B are example operation screens of the image processing apparatus. On an application window screen 1300 illustrated in FIG. 13A, an image 1301R obtained by converting the image from the first optical system 201R into an equidistant cylindrical projection image is displayed as a left-eye image. An image 1301L obtained by converting the image from the second optical system 201L into an equidistant cylindrical projection image is displayed as a right-eye image.

Atilt correction checkbox 1302 and an upside-down imaging checkbox 1303 are displayed on the window screen 1300. The user can switch whether or not to perform tilt correction by switching on and off the checkbox 1302. The user can switch whether or not to use the upside-down imaging mode by switching on and off the checkbox 1303.

For example, as illustrated in FIG. 13B, in a case where the checkbox 1303 is checked, an image 1301R obtained by converting the image from the first optical system 201R is displayed as a left-eye image, and an image 1301L obtained by converting the image from the second optical system 201L is displayed as a right-eye image. For example, the determinations in steps S1201, S1202, and S1206 in FIG. 12 are performed depending on whether checkboxes 1302 and 1303 are turned on or off.

In the above description, the user can select the upside-down imaging mode and the tilt correction, but the application may determine whether each of them is to be performed based on an image that includes attitude data during imaging.

As described above, assume that an x-axis is a horizontal direction of the image pickup apparatus 100 illustrated in FIG. 5A, a y-axis is a vertical direction, and a z-axis is a depth direction, and the image pickup apparatus 100 can acquire the gravity direction G as attitude data using the attitude detector 119 such as an acceleration sensor. For example, in a case where the image pickup apparatus 100 is in a normal attitude illustrated in FIG. 5A, the gravity direction G is defined as x=0, y=−1, and z=0. In the case of a completely upside-down attitude, the gravity direction G is defined as x=0, y=1, z=0. The determination of the upside-down attitude may use a threshold somewhere between the normal attitude and the completely upside-down attitude, and determine whether or not the value exceeds the threshold. Here, the x-component, y-component, and z-component in the gravity direction G each take a value in a range of −1 or more and 1 or less, and the scalar of the three-dimensional vector including these components is 1. In other words, each component is output so that √(x²+y²+z²)=1 is met.

A description will now be given of the threshold for determining the upside-down attitude. For example, assume that regarding the y-axis of the image pickup apparatus 100, in a case where the image pickup apparatus 100 is in the normal attitude, the value of the y-component indicating the gravity direction G is negative, and in a case where the image pickup apparatus 100 is in the upside-down attitude, the value of the y-component indicating the gravity direction G is positive. Then, the upside-down attitude can be determined by determining whether the y-component is positive or negative, that is, using the threshold 0 for the y-component.

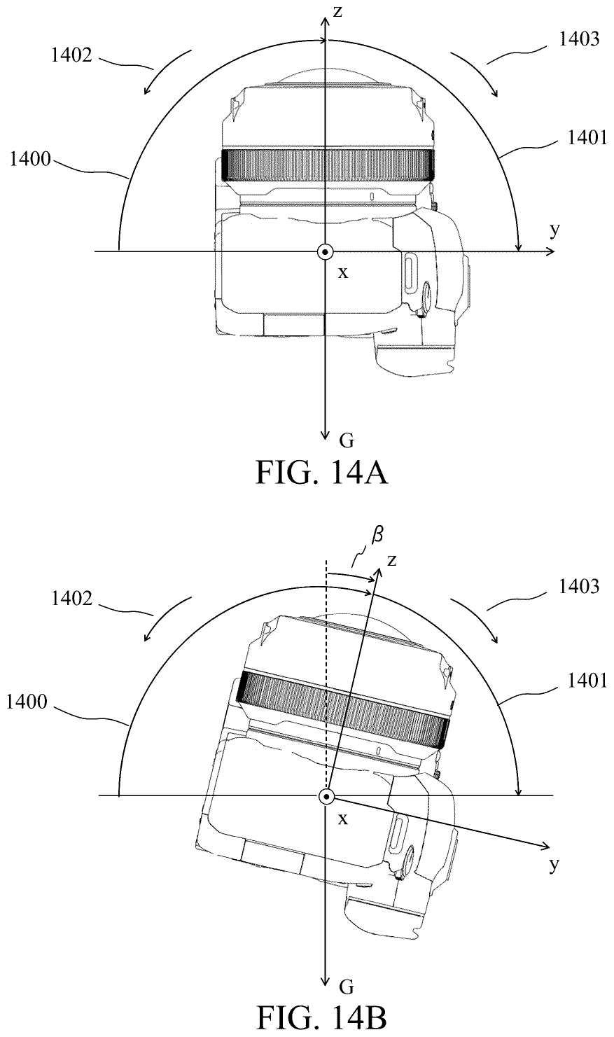

FIGS. 14A and 14B are side views of the image pickup apparatus 100 in an upward attitude. In FIG. 14A, for simplicity purposes, consider an attitude in which the image pickup apparatus 100 is rotated in an upward direction from the normal attitude around the x-axis. In a case where y=0 is set to the threshold, as illustrated in FIG. 14A, a normal imaging determination area 1400 ranges from the normal attitude of the image pickup apparatus 100 to an attitude for imaging right above, and an upside-down imaging determination area 1401 ranges from the attitude for imaging right above to a completely upside-down attitude. In other words, in terms of the angle around the x-axis, the normal imaging determination area 1400 ranges from the normal attitude to an attitude with a rotation angle of 90° around the x-axis, and the upside-down imaging determination area 1401 ranges from the attitude with the rotation angle of 90° around the x-axis to an attitude with the rotation angle of 180° around the x-axis.

In a case where an image captured in an attitude within the normal imaging determination area 1400 is horizontalized, the image is rotated in a tilt correcting direction 1402 illustrated in FIG. 14A for tilt correction so that the z-axis direction as the forward imaging direction of the image pickup apparatus 100 is horizontal. That is, the forward imaging direction of the image pickup apparatus 100 is corrected to the left direction in FIG. 14A.

In a case where an image captured in an attitude within the range of the upside-down imaging determination area 1401 is horizontalized, the image is rotated in a tilt correcting direction 1403 illustrated in FIG. 14A for tilt correction so that the z-axis direction as the forward imaging direction of the image pickup apparatus 100 is horizontal. That is, the forward imaging direction of the image pickup apparatus 100 is corrected to the right direction in FIG. 14A.

In imaging at an attitude facing almost right above, a direction in which the VR image is displayed is reversed if tilt correction is performed between the normal imaging mode and the upside-down imaging mode. In a case where the application makes automatic determination regardless of the user's intention, the determination of upside-down imaging may be different from the user's intention. For example, in imaging a starry sky, the user may direct the image pickup apparatus 100 right above as illustrated in FIG. 14A. Now assume that the user performs imaging while facing right above, and the tilt correction is performed in the normal imaging mode. However, if the image pickup apparatus 100 is tilted slightly toward the upside-down imaging determination area 1401 from right above, the application may determine that the image pickup apparatus 100 is in the upside-down attitude, and the tilt correction may be performed in upside-down imaging mode against the user's intention. In a case where the user performs hand-held imaging, the upside-down imaging determination is more likely to be made against the user's intention. In imaging multiple times, even if the user thinks he is facing right above in the same attitude, some of the captured images may be determined to belong to normal imaging, and others may be determined to belong to upside-down imaging. As a result, in a case where a plurality of horizontalized images are displayed, these displayed images include images horizontalized by different methods. Therefore, it is not proper to set the threshold to y=0 for automatic upside-down imaging determination.

Accordingly, as illustrated in FIG. 14B, this embodiment sets the normal imaging determination area 1400 from the normal attitude to an attitude rotating around the x-axis by an angle of 90 degrees+a predetermined angle β, and the upside-down imaging determination area 1401 from the attitude rotating around the x-axis by an angle of (90+β) degrees to an attitude rotating around the x-axis by an angle of 180 degrees. Thereby, the upside-down imaging determination (wrong determination) contrary to the user's intention as described above can be less likely.

By setting the value of the y-component in the gravity direction determined by the acceleration sensor to sin β instead of 0, as mentioned above, the upside-down imaging determination against the user's intention can be restrained in the case of a slight shift from the right above attitude. In a case where the y-component in the gravity direction is in the range of values from −1 to sin β, it is determined to be normal imaging, and in a case where the y-component in the gravity direction is in the range of values from sin β to 1, it is determined to be upside-down imaging. For example, a value such as 5° or 10° is adopted as β, but the value is not limited to this example. By setting β to a value larger than 0, as illustrated in FIG. 14B, the normal imaging determination area (first range) 1400 where normal imaging is determined is larger than the upside-down imaging determination area (second range) 1401 where upside-down imaging is determined.

In automatic upside-down imaging determination, this embodiment may set a calculated roll correction value of 90°+γ as a threshold. As described above, in a case where the tilt angle in the roll direction is 90 degrees, the horizontal parallax becomes zero, and when it exceeds 90 degrees, the sign of the horizontal parallax becomes reversed. A practically stereoscopic viewable image cannot be acquired simply by horizontalizing images captured in the vertical attitude rotated by 90 degrees in the roll direction. However, setting the roll correction value 90°+γ as the threshold can provide an effect similar to that in determining from the y-component of the acceleration sensor described above. The roll correction value described above is calculated from the values of the x-component, y-component, and z-component of the gravity direction in the attitude data by the attitude detector 119 such as the acceleration sensor described above. Therefore, it is equivalent to setting a certain value of the y-component in the gravity direction as a threshold.

An example has hitherto been described in which the attitude of the image pickup apparatus 100 is read from the attitude data recorded in a captured image and it is determined whether it is normal imaging or upside-down imaging. The attitude of the image pickup apparatus 100 may also be determined by processing within the image pickup apparatus 100 in an pre-imaging state, e.g., in a live-view state. By adding a function of determining the attitude in advance to imaging and notifying the user of it or the like, the user can recognize in advance which mode should be used to process the image after imaging, or which mode is automatically determined.

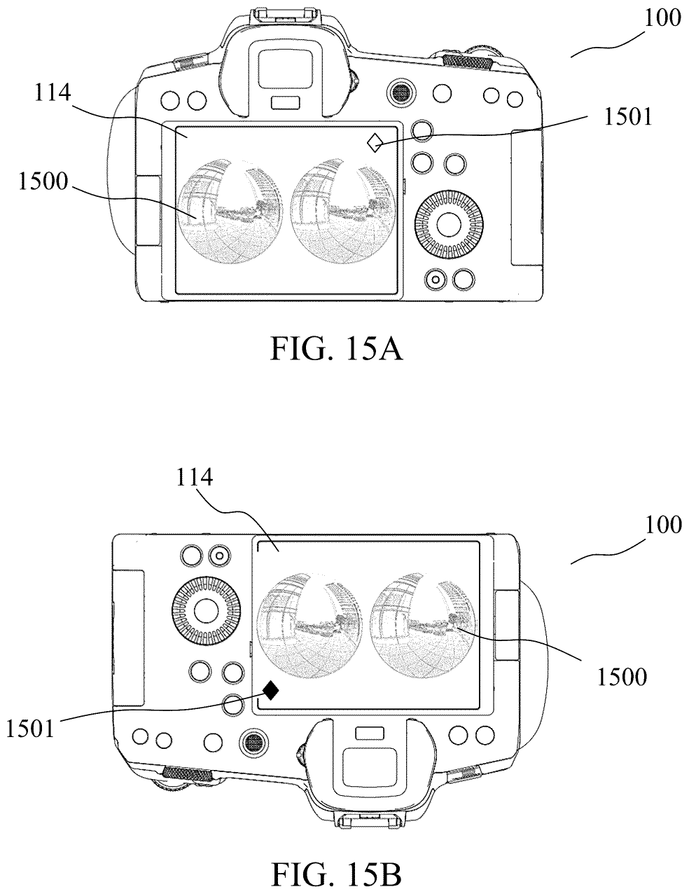

FIGS. 15A and 15B are example live-view images of the image pickup apparatus 100. As illustrated in FIGS. 15A and 15B, the user can previously recognize the determination result by the image pickup apparatus 100 by displaying an attitude determination mark 1501 in live-view display 1500. For example, a white diamond mark is displayed as illustrated in FIG. 15A in a case where normal imaging is determined, and a black diamond mark is displayed as illustrated in FIG. 15B in a case where upside-down imaging is determined. Thereby, the user can recognize the determination result. The display content for notifying the user of the determination result is not limited to the diamond mark, and may be another mark or character.

At this time, the user may be able to select normal imaging or upside-down imaging during live-view display before imaging. For example, in a case where the user selects normal imaging, even if the image pickup apparatus 100 automatically determines that it is in the upside-down imaging determination area, a flag indicating the normal imaging can be attached and saved in the imaging data. In converting imaging data with the flag of normal imaging by an application, the flag may be given priority in determination over the attitude data for the following image processing.

Next, in a case where the attitude of the image pickup apparatus 100 changes during moving image capturing, e.g., from the normal attitude to the upside-down attitude, and attitude data is referring to in real time, the image pickup apparatus 100 determines that it is in the upside-down attitude during imaging. Then, the right-eye image and the left-eye image are exchanged during moving image capturing, which affects VR viewing. Therefore, the attitude change may not be set during moving image capturing. For example, the user can capture a moving image by attaching a determination flag of the normal attitude or upside-down attitude. Alternatively, the attitude may be determined based on the attitude data of a certain frame in the moving image, and the determination may be applied to all frames.

In this embodiment, the image pickup apparatus 100 includes a camera body 110 and an interchangeable lens 200 that is attachable to and detachable from the camera body 110, but the image pickup apparatus may be an image pickup apparatus in which the lens and the camera body are integrated. In this embodiment, an image from the first optical system 201R and an image from the second optical system 201L are captured by the same image sensor 111, but this embodiment is not limited to this example. For example, an image sensor that captures an image from the first optical system 201R and an image sensor that captures an image from the second optical system 201L may be provided, respectively.

### Otter Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each embodiment can provide an image processing apparatus that can generate correctly viewable VR images regardless of the attitude of the image processing apparatus during imaging.

This application claims priority to Japanese Patent Application No. 2023-123529, which was filed on Jul. 28, 2023, and which is hereby incorporated by reference herein in its entirety.

What is claimed is:

1. An image processing apparatus comprising:
a memory storing instructions; and
a processor configured to execute the instruction to:
acquire a first image and a second image with parallax, or one image including the first image and the second image,
output one stereoscopic viewable image by setting the first image as a right-eye image and the second image as a left-eye image in a first mode, and
output one stereoscopic viewable image by setting the first image as the left-eye image and the second image as the right-eye image, and by rotating the first image and the second image around an optical axis in a second mode.

2. The image processing apparatus according to claim 1, wherein the processor is configured to rotate the first image and the second image by 180 degrees around the optical axis in the second mode.

3. The image processing apparatus according to claim 1, wherein in the stereoscopic viewable image, the left-eye image is disposed on a left side, and the right-eye image is disposed on a right side.

4. The image processing apparatus according to claim 1, wherein in the stereoscopic viewable image, the left-eye image is disposed on a top side, and the right-eye image is disposed on a bottom side.

5. The image processing apparatus according to claim 1, wherein the stereoscopic viewable image is an image converted using an equidistant cylindrical projection method.

6. The image processing apparatus according to claim 1, wherein the stereoscopic viewable image is a fisheye image that includes conversion coordinate information and information for determining either the left-eye image or the right-eye image.

7. The image processing apparatus according to claim 1, wherein the processor is configured to obtain attitude data of an image pickup apparatus that has generated the first image and the second image, and
wherein based on the attitude data, the processor is configured to determine which of the first mode and the second mode is to be used for image processing to the first image and the second image.

8. The image processing apparatus according to claim 7, wherein in the attitude data, a first range of the attitude data determined to belong to the first mode is wider than a second range of the attitude data determined to belong to the second mode.

9. The image processing apparatus according to claim 1, wherein the processor is configured to obtain attitude data of an image pickup apparatus that has generated the first image and the second image, and
wherein the processor is configured to obtain a tilt correcting value based on the attitude data, and outputs the stereoscopic viewable image that has been horizontalized based on the tilt correcting value.

10. The image processing apparatus according to claim 9, wherein a rotation correcting angle around the optical axis of the stereoscopic viewable image horizontalized in the first mode relative to an input image, and a rotation correcting angle around the optical axis of the stereoscopic viewable image horizontalized in the second mode relative to an input image are different from each other.

11. An image pickup apparatus configured to acquire a first image and a second image with parallax, the image pickup apparatus comprising:
a first optical system;
a second optical system disposed in parallel with the first optical system; and
a processor configured to:
acquire the first image and the second image with parallax, or one image including the first image and the second image,
output one stereoscopic viewable image by setting the first image as a right-eye image and the second image as a left-eye image in a first mode, and
output one stereoscopic viewable image by setting the first image as the left-eye image and the second image as the right-eye image, and by rotating the first image and the second image around an optical axis in a second mode.

12. The image pickup apparatus according to claim 11, wherein the processor is configured to rotate the first image and the second image by 180 degrees around the optical axis in the second mode.

13. The image pickup apparatus according to claim 11, wherein the first optical system is disposed on a right side when viewed from a back side of the image pickup apparatus,
wherein the second optical system is disposed on a left side when viewed from the back side of the image pickup apparatus,
wherein the first image is formed by the first optical system, and
wherein the second image is formed by the second optical system.

14. The image pickup apparatus according to claim 11, further comprising attitude detector configured to detect an attitude of the image pickup apparatus during capturing the first image and the second image and to outputting attitude data.

15. The image pickup apparatus according to claim 14, wherein the processor is configured to determine which of the first mode and the second mode is to be used, based on the attitude data.

16. The image pickup apparatus according to claim 11, further comprising a display unit configured to display which of the first mode and the second mode is to be used for image processing to the first image and the second image.

17. The image pickup apparatus according to claim 11, wherein at least one of the first image and the second image includes data indicating which of the first mode and the second mode is to be used for image processing to the first image and the second image.

18. The image pickup apparatus according to claim 17, wherein based on the attitude data, the processor is configured to determine which of the first mode and the second mode is to be used for image processing to the first image and the second image.

19. An image pickup method comprising the steps of:
acquiring a first image and a second image with parallax, or one image including the first image and second image,
outputting one stereoscopic viewable image by setting the first image as a right-eye image and the second image as a left-eye image in a first mode, and
outputting one stereoscopic viewable image by setting the first image as the left-eye image and the second image as the right-eye image, and by rotating the first image and the second image around an optical axis in a second mode.

20. A non-transitory computer-readable storage medium storing a program that causes a computer to execute the image pickup method according to claim 19.
